(19) United States
(12) Patent Application Publication
(10) Pub. No.: US 2020/0367630 A1
(43) Pub. Date: Nov. 26, 2020

(54) A FRAME UNIT

(71) Applicant: KONINKLIJKE PHILIPS N.V., EINDHOVEN (NL)

(72) Inventors: Geert-Jan DARWINKEL, WINSUM (NL); Cornelis Johannes ZANDSTEEG, IJSSELMUIDEN (NL); Lolke Klaas SALVERDA, BEETSTERZWAAG (NL); Jeroen KEIJER, GRONINGEN (NL); Roderik DE VRIES, EINDHOVEN (NL); Taeke VAN DER WOUDE, OOSTERWOLDE (NL)

(21) Appl. No.: 16/769,678

(22) PCT Filed: Dec. 7, 2017
(86) PCT No.: PCT/EP2017/081902

§ 371 Date: Jun. 4, 2020

(51) Int. Cl. A45D 24/36; B26B 19/38; B26B 21/40

(52) U.S. Cl. CPC A45D 24/36; B26B 21/4081; B26B 19/388; B26B 19/3826

(57) ABSTRACT

There is provided a frame unit (10, 30, 60, 70) for use in a hair clipping system. The frame unit comprises a frame (110, 310, 610, 710); a first ear portion (120, 320, 620, 720) for supporting the frame at the first ear of the subject; at least one of a nose portion (140, 340, 640, 740) for supporting the frame on the nose of the subject and a second ear portion (130, 330, 630) for supporting the frame at the second ear of the subject. The frame interconnects the first ear portion and the at least one of the nose portion and the second ear portion. Also, the frame extends below a line interconnecting the first ear portion and the at least one of the nose portion and the second ear portion while in use on a subject so as to enable access to the side of the face of the subject by a hair clipping unit.

### FIELD OF THE INVENTION

The present disclosure relates to a frame unit for use in a hair clipping system.

### BACKGROUND OF THE INVENTION

There are currently applications available in the field of automatic haircut creation (e.g. using an automated hair cutting device) which involves performing calibration using electromagnetic sensors respectively placed near the ear and the nose of a subject. A user may select a hairstyle which is defined mathematically in a software, and this mathematical hairstyle definition can be applied to a subject's head so as to allow a hair clipping operation to be performed. An example of such an automatic haircut creation system is disclosed by WO2014/163999A1. A further example is disclosed by WO2013/096572A1.

Since the size and shape of heads differ significantly between users, in particular between adults and children, it is important to take into account the size and shape of the subject's head during the hair clipping operation so that a desired hairstyle can be achieved accurately. If the subject's head is not scaled properly, the resulting hairstyle may be different from what is intended. Therefore, in some known applications, multiple sensors are used for the purpose of subject head calibration.

### SUMMARY OF THE INVENTION

Some currently available applications adopt two sensors positioned respectively near each ear of the subject so as to calibrate and localize a position and/or orientation of a hair clipper. However, it is found from a number of consumer tests that users are likely to encounter difficulties when performing any type of calibration operation. Also, some users may find it time consuming to perform calibration. Accordingly, it is important to implement a user-intuitive and straightforward way to allow users to initiate calibration of the hair clipping system.

Moreover, if only two sensors are used, there is a risk in erroneous measurements of the position of the hair clipper due to the possibility of multiple mathematical solutions. Hence, some applications employ an additional sensor positioned near the nose of the subject so as to attain more accurate position measurements of the hair clipper. For example, some solutions adopt a frame configuration similar to that of eyeglasses so as to accommodate multiple sensors. A disadvantage of such configuration is that parts of the face or head of the subject may be obstructed and therefore sometimes hair clipping operations cannot be completed while the frame is in use on the subject.

In addition, many of the currently available solutions for automatic haircut creation suffer a number of other drawbacks. For example, some of the sensors used in these solutions may be prone to fall off or dislocate during a haircut operation due to head movement. Also, in some of these solutions the sensors may be temporarily fixed near the head of the subject by means of hooks (e.g. a hook around an ear of the subject). These or other types of fixation means may cause restriction of access to certain areas of the face or the head, which increases the difficulty of the hair clipping process.

It would therefore be advantageous to provide a frame unit for use in a hair clipping system which enables access to sides of the face of the subject by a hair clipping unit. It would also be desirable to provide a frame unit for use in a hair clipping system which can be adjusted to fit onto different sizes and shapes of heads and can be securely fitted onto the head of a subject.

To better address one or more of these concerns, in a first aspect there is provided a frame unit for use in a hair clipping system, the frame unit comprising: a frame; a first ear portion for supporting the frame at the first ear of the subject; at least one of a nose portion for supporting the frame on the nose of the subject and a second ear portion for supporting the frame at the second ear of the subject, wherein the frame interconnects the first ear portion and the at least one of the nose portion and the second ear portion, and wherein the frame is configured such that, while in use on a subject, the frame extends below a line interconnecting the first ear portion and the at least one of the nose portion and the second ear portion to enable access to the side of the face of the subject by a hair clipping unit in the hair clipping system.

In some embodiments, the frame may be shaped such that the frame extends substantially vertically downwards from the first ear portion to a first position and extends upwards from the first position to the at least one of the nose portion and the second ear portion.

In some embodiments, the frame unit may comprise the nose portion and a first hinge at the first position that enables the distance between the first ear portion and the nose portion to be adjusted. In these embodiments, the first hinge may be configured such that the first ear portion and the nose portion are biased towards each other.

In some embodiments, the frame unit may comprise the nose portion and the second ear portion, and wherein the frame may interconnect the first ear portion and the second ear portion via the nose portion, and wherein the frame may be configured such that, while in use on a subject, the frame extends below a line interconnecting the second ear portion and the nose portion to enable access to the other side of the face of the subject by the hair clipping unit. In these embodiment, the frame may be configured such that the frame extends substantially vertically downwards from the second ear portion to a second position and extends upwards from the second position to the nose portion.

Moreover, in these embodiments, the frame unit may comprise a second hinge at the second position that enables the distance between the second ear portion and the nose portion to be adjusted. The second hinge may be configured such that the second ear portion and the nose portion are biased towards each other.

In some embodiments, the frame may be configured such that the first ear portion and the second ear portion are biased towards each other.

In some embodiments, the frame unit may further comprise at least a first component positioned on the frame for use in measuring a characteristic of the head of the subject and/or a characteristic of the hair clipping unit in the hair clipping system. In these embodiments, the characteristic of the head of the subject may comprise at least one of a size of the head of the subject and a shape of the head of the subject, and/or wherein the characteristic of the hair clipping unit may comprise at least one of a position and an orientation of the hair clipping unit relative to the frame unit. Moreover, in these embodiments, the frame unit may comprise a second component positioned on the frame for use in measuring the characteristic of the head of the subject and/or the characteristic of the hair clipping unit in the hair clipping system, wherein the first component may be positioned at or near the first ear portion, and the second component may be positioned at or near the at least one of the nose portion and second ear portion.

In some embodiments, the first component and the second component may be configured to measure the distance therebetween to determine the size of the head.

In some embodiments, the characteristic of the hair clipping unit may be the position of the hair clipping unit relative to the frame unit. In these embodiments, the frame unit may comprise an actuation unit at a predetermined position on the frame unit for initiating a measurement of the position of the hair clipping unit. The actuation unit may be configured to be actuated by a component of the hair clipping unit.

In a second aspect, there is provided a system comprising a frame unit according to any of the preceding claims, the system further comprising a control unit configured measure a characteristic of the head of the subject and/or a characteristic of the hair clipping unit.

In some embodiments, the control unit may be configured to determine a hair cutting pattern for use by a user in operating the hair clipping unit based on the measured characteristic of the head of the subject and/or the characteristic of the hair clipping unit.

In some embodiments, the system may further comprise a hair clipping unit.

These and other aspects of the invention will be apparent from and elucidated with reference to the embodiment(s) described hereinafter.

### BRIEF DESCRIPTION OF THE DRAWINGS

For a better understanding of the embodiments, and to show more clearly how they may be carried into effect, reference will now be made, by way of example only, to the accompanying drawings, in which:

FIG. 1 is a block diagram of a frame unit for use in a hair clipping system, according to an embodiment;

FIG. 2 is a block diagram of a system according to another embodiment;

FIG. 3A is a schematic drawing of the frame unit according to another embodiment;

FIG. 3B is a schematic drawing of the frame unit of FIG. 3A while in use on a subject;

FIG. 4A and FIG. 4B are schematic drawings illustrating how the frame unit of FIG. 3A and FIG. 3B can be adjusted;

FIG. 5A to FIG. 5C are schematic drawings demonstrating how the frame unit of FIG. 3A and FIG. 3B can be fitted onto the head of a subject;

FIG. 6A and FIG. 6B are schematic drawings illustrating how a characteristic of the head of a subject may be measured by measuring distances between components on a frame unit, according to another embodiment;

FIG. 7A is a schematic drawing of a frame unit for use in a hair clipping system according to another embodiment;

FIG. 7B is a schematic drawing of the frame unit of FIG. 7A while in use on a subject;

FIG. 8A and FIG. 8B are schematic drawings demonstrating how an actuation unit on the frame unit of FIG. 7A and FIG. 7B can be actuated by a hair clipping unit.

### DETAILED DESCRIPTION OF THE EMBODIMENTS

As noted above, there is provided an improved frame unit and a system comprising the same which address the existing problems.

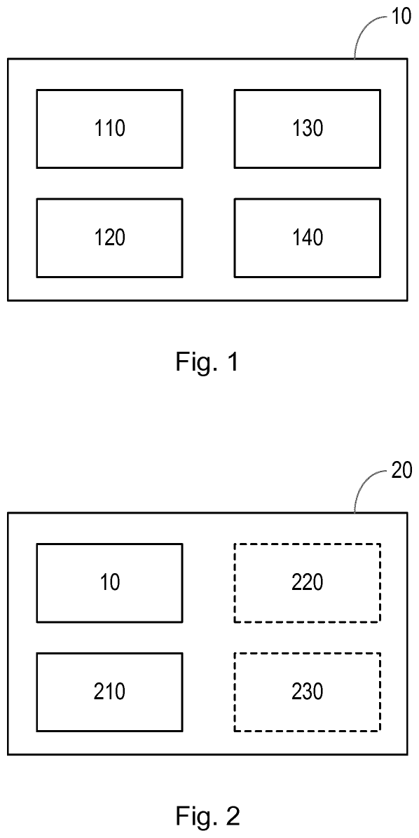

FIG. 1 is a block diagram of a frame unit 10 for use in a hair clipping system. The frame unit 10 comprises a frame 110, a first ear portion 120, and at least one of a nose portion 140 and a second ear portion 130. In this embodiment, the frame unit comprises both of the nose portion 140 and the second ear portion 130. However, in some embodiments the frame unit 10 may only comprise one of the nose portion 140 and the second ear portion 130.

The first ear portion 120 is for supporting the frame 110 at the first ear of the subject. The second ear portion 130 is for supporting the frame 110 at the second ear of the subject. The nose portion 140 is for supporting the frame 110 on the nose of the subject. The frame 110 interconnects the first ear portion 120 and the at least one of the nose portion 140 and the second ear portion 130. Furthermore, the frame 110 is configured such that, while in use on a subject, the frame 110 extends below a line interconnecting the first ear portion 120 and the at least one of the nose portion 140 and the second ear portion 130 to enable access to the side of the face of the subject by a hair clipping unit in the hair clipping system.

In some embodiments where the frame unit 10 comprises the second ear portion 130, the frame 110 may be configured such that the first ear portion 120 and the second ear portion 130 are biased towards each other. For example, the frame unit 10 may be made of elastic material to achieve an elastic bias configuration. As another example, a spring-loaded hinge may be provided at the nose portion such that the first ear portion 120 and the second ear portion 130 are biased towards each other.

Although not shown in FIG. 1, the frame unit 10 may further comprise at least a first component on the frame 110 for use in measuring a characteristic of the head of the subject and/or a characteristic of the hair clipping unit in the hair clipping system. In some embodiments, the characteristic of the head of the subject may comprise at least one of a size of the head of the subject and a shape of the head of the subject. Also, in some embodiments, the characteristic of the hair clipping unit may comprise at least one of a position and/or an orientation of the hair clipping unit relative to the frame unit 110, and a position and/or an orientation of a cutting element of the hair clipping unit relative to the frame unit 110. The first component may be a passive component, such as a reflector element, or an active component, such as an electromagnetic sensor.

Moreover, in some of the embodiments where the frame unit 10 comprises a first component, the frame unit 10 may further comprise a second component positioned on the frame 110 for use in measuring the characteristic of the head of the subject and/or the characteristic of the hair clipping unit in the hair clipping system. In these embodiments, the first component may be positioned at or near the first ear portion 120, and the second component may be positioned at or near the at least one of the nose portion 140 and the second ear portion 130. Similar to the first component, the second component may be a passive component or an active component (e.g. an electromagnetic sensor). The distance between the first component and the second component can therefore be determined in some of these embodiments, for example by an external control unit (not shown in FIG. 1).

In some embodiments, the frame unit 10 may further comprise a communications unit configured to interface with an external control unit and/or the hair clipping unit in the hair clipping system through a wireless or wired connection.

Although not shown in FIG. 1, in some embodiments the frame unit 10 may further comprise a nose pad positioned at or near the nose portion 140. The nose pad may be configured to conform to a shape of the subject's nose while the frame unit 10 is in use on the subject.

It will be appreciated that the described embodiment may be applicable for use in hair clipping systems which comprise any type of device that is used to cut hair (e.g. hair clippers, razors, electric shavers). Therefore, the term “hair clipping unit” will be understood to embody any type of device that can be used to cut hair. Moreover, it will be appreciated that the described embodiments may be applicable for use with other types of personal care devices, including oral healthcare devices (e.g. electric toothbrushes) and beauty devices (e.g. face cleansing devices).

It will also be appreciated that FIG. 1 only shows the components required to illustrate this aspect of the frame unit and, in a practical implementation, the frame unit 10 may comprise additional components to those shown. For example, the frame unit 10 may comprise a battery or other power supply for powering the frame unit 10 or means for connecting the frame unit 10 to a mains power supply. As another example, the frame unit 10 may further comprise an actuation unit positioned at a predetermined position on the frame unit 10 for initiating a measurement of the position of the hair clipping unit.

FIG. 2 is a block diagram of a system according to another embodiment. The system 20 comprises the frame unit 10 as described above with reference to FIG. 1, a control unit 210, a hair clipping unit 220, and an interface unit 230. The hair clipping unit 220 may be any type of device that can be used to cut hair. In some embodiments, the system 20 may not comprise a hair clipping unit and in these embodiments the control unit 210 may be configured to communicate with an external hair clipping unit (in a separate hair clipping system, for example). In some embodiments, the system 20 may not comprise an interface unit.

The control unit 210 is configured to measure a characteristic of the head of the subject and/or a characteristic of the hair clipping unit. As described above with reference to FIG. 1, the frame unit 10 may comprise at least a first component on the frame for use in measuring a characteristic of the head of the subject and/or a characteristic of the hair clipping unit. Hence, in the present embodiment, the control unit 210 may be configured to perform measurement of the characteristic using at least the first component at the frame unit 10. For example, in some embodiments the first component at the frame unit 10 may be a sensor (e.g. an electromagnetic sensor). The control unit 210 in these embodiments may be configured to receive a signal from the first component so as to allow at least one of a characteristic of the head of the subject and/or a characteristic of the hair clipping unit to be measured.

It is also described above with reference to FIG. 1 that in some embodiments the frame unit 10 may further comprise a second component for use in measuring the characteristic of the head of the subject and/or the characteristic of the hair clipping unit, together with first component, wherein the first component is positioned at or near the first ear portion 120, and the second component is positioned at or near the second ear portion 130. In these embodiments, the distance between the first component and the second component may be measured, and the measurement may be performed by the control unit 210 of the system 20. Since the first component is positioned at or near the first ear portion and the second component is positioned at or near the second ear portion 130, the distance between the first component and the second component is indicative of the width of the head of the subject. Hence, in these embodiments the control unit 210 may be configured to measure a characteristic of the head of the subject, such as the size and/or the shape of the head based on the measured distance between the first component and the second component.

In some embodiments, the control unit 210 may be configured to determine a hair cutting pattern for use by a user in operating the hair clipping unit based on the measured characteristic of the head of the subject and/or the characteristic of the hair clipping unit. For example, the hair cutting pattern may be determined by scaling and/or adjusting a preset hair cutting pattern according to a size of the head of the subject. The hair cutting pattern may comprise instructions relating to control of the hair clipping unit, for example a length of a comb at the hair clipping unit. More specifically, in some embodiments, the hair cutting pattern may comprise a table which defines a corresponding desired hair length at each of a plurality of predetermined positions, wherein each of the plurality of predetermined positions may be represented by coordinates. In these embodiments, the hair clipping unit may be controlled according to a desired hair length at a measured position of the hair clipping unit (relative to the frame unit). A desired hair length at a measured position of the hair clipping unit may be determined (e.g. by the control unit 210) by interpolating from the corresponding desired hair length at one or more of the plurality of specific positions as indicated in the hair putting pattern.

The interface unit 230 of the system 20 may be configured to interface with at least one of the frame unit 10 and the hair clipping unit 220. Specifically, in some embodiments, the interface unit 230 may be configured to interface with a component (e.g. a sensor) at the frame unit 10. For example, in some embodiments the interface unit 230 may receive a signal from a component from the frame unit 10 for use in the measurement of a characteristic of the head of the subject.

In some embodiments where the system 20 comprises a frame unit having a first ear portion, a second ear portion, and a nose portion, the control unit 210 of this system 20 may be configured to determine an angle between a first part of the frame unit and a second part of the frame unit, wherein the first part of the frame unit corresponds to a part of the frame between the first ear portion and the nose portion, and the second part of the frame unit corresponds to a part of the frame between the second ear portion and the nose portion. In these embodiments, the control unit 210 of the system 20 may be further configured to determine whether the angle between the first part of the frame unit and the second part of the frame unit exceeds a predetermined angle threshold for a predetermined time period (e.g. 5 seconds). If it is determined that the angle between the first part and the second part exceeds the predetermined angle threshold for the predetermined time period, the control unit 210 may be configured to perform at least one of: powering on the system 20, powering on the frame unit 10, pairing a component of the frame unit with the interface unit 230, and initiating a measurement of a characteristic of the head of the subject and/or a characteristic of the hair clipping unit 220. The pairing may be performed using Bluetooth, radiofrequency, or electromagnetic field.

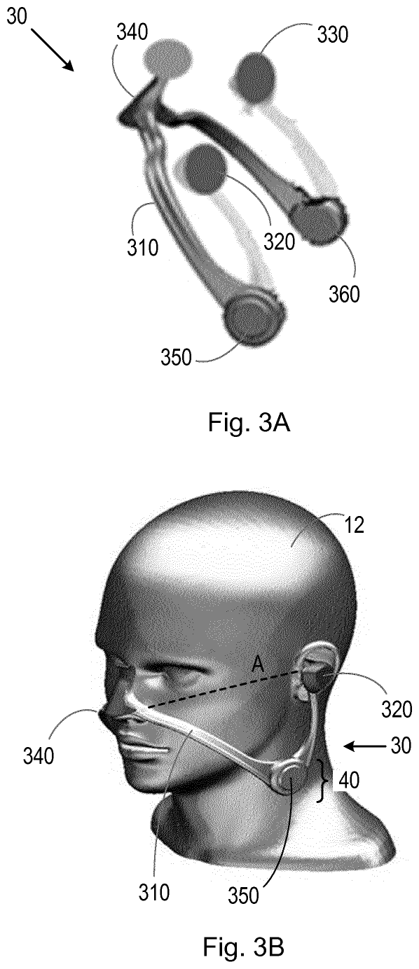

FIG. 3A is a schematic drawing of the frame unit according to another embodiment, and FIG. 3B is a schematic drawing of the frame unit of FIG. 3A while in use on a subject. The frame unit 30 according to this embodiment comprises a frame 310, a first ear portion 320, a second ear portion 330, and a nose portion 340.

As shown in FIG. 3A and FIG. 3B, in this embodiment the frame 310 interconnects the first ear portion 320 and the second ear portion 330, and also interconnects the first ear portion 320 and the nose portion 340. More specifically, the frame 310 interconnects the first ear portion 320 and the second ear portion 330 via the nose portion 340.

Moreover, as shown in FIG. 3B, the frame 310 is configured such that, while in use of a subject 12, the frame 310 extends below a line A interconnecting the first ear portion 320 and the nose portion 340. In a symmetrical manner, the frame 310 also extends below a line interconnecting the second ear portion 330 and the nose portion 340. This is at least partly due to the fact that the frame 310 is shaped such that on one side it extends substantially vertically downwards from the first ear portion 320 to a first position 40 and extends upwards from the first position 40 to the nose portion 340. On the other side, it also extends substantially vertically downwards from the second ear portion 330 to a second position (not shown in FIG. 3A or FIG. 3B) and extends upwards from the second portion to the nose portion 340. Therefore, while in use on a subject, the frame 310 enables both sides of the face of the subject to be accessed by a hair clipping unit. Also, glasses or spectacles can be worn by the subject during a hair clipping operation. The physical configuration of the frame unit 30 is user-intuitive, which reduces the likelihood of incorrect placement (e.g. upside down, left-right swapping) on the head of the subject.

The frame unit 30 in this embodiment further comprises a first hinge 350 at the first position 40 that enables the distance between the first ear portion 320 and the nose portion 340 to be adjusted. In some embodiments, the first hinge 350 may be configured such that the first ear portion 320 and the nose portion 340 are biased towards each other. This may be achieved by means of using an elastic (e.g. spring-loaded) element at the first hinge 350.

In addition, referring to FIG. 3A, the frame unit 30 in this embodiment further comprises a second hinge 360 at the second position that enables the distance between the second ear portion 330 and the nose portion 340 to be adjusted. In some embodiments, the second hinge 360 may be configured such that the second ear portion 330 and the nose portion 340 are biased towards each other. Similarly, this may be achieved by means of using an elastic (e.g. spring-loaded) element at the second hinge 360.

Similar to the frame unit 10 described with reference to FIG. 1, the frame unit 30 of the present embodiment may also further comprise at least a first component on the frame 310 for use in measuring a characteristic of the head 12 of the subject and/or a characteristic of the hair clipping unit in the hair clipping system. In addition, the frame unit 30 may be incorporated in a system which further comprises a control unit, such that a characteristic of the head of the subject and/or a characteristic of the hair clipping unit in the hair clipping system may be measured by the control unit based on signal(s) from at least the first component of the frame unit 30.

Although it is described in an embodiment above that the frame is shaped such that it extends from the first portion to the nose portion, in alternative embodiments the frame unit may comprise a second ear portion and not a nose portion. In these alternative embodiments, the frame may be shaped such that it extends substantially vertically downwards from the first ear portion to a first position and extends upwards from the first position to the second ear portion. In these embodiments, the first position may be located adjacent the chin of a subject while the frame unit is in use on the subject. In these embodiments, a hinge may be provided at the first position for biasing the first ear portion and the second ear portion towards each other. Additionally or alternatively, the frame 310 may be configured such that the first ear portion 320 and the second ear portion 130 are biased towards each other.

Although it is described in an embodiment above that the frame is shaped such that it interconnects the first ear portion and the second ear portion via the nose portion, in alternative embodiments the frame unit may comprise a nose portion and not a second ear portion. In these embodiments, the frame unit may not comprise a second hinge.

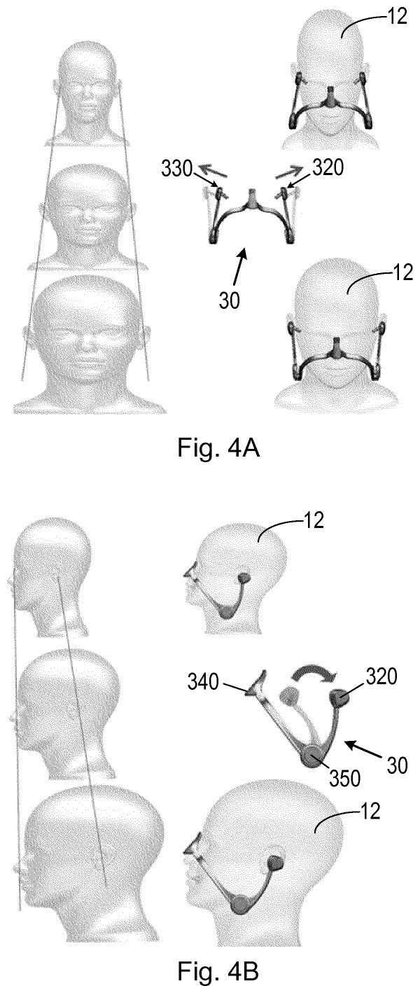

FIG. 4A and FIG. 4B are schematic drawings illustrating how the frame unit 30 of FIG. 3A and FIG. 3B can be adjusted.

As described above with reference to FIG. 3A and FIG. 3B, in some embodiments the frame 310 may be configured such that the first ear portion 320 and the second ear portion 330 are biased towards each other. In these embodiments, the frame unit 30 may be fitted onto the head of the subject by applying a force on the frame unit 30 so as to pull the first ear portion 320 and the second ear portion 330 away from each other momentarily, such that the distance between the first ear portion 320 and the second ear portion 330 is equal to or larger than the width of the head of the subject, as indicated by the arrows in FIG. 4A.

Additionally, as described above with reference to FIG. 3A and FIG. 3B, in some embodiments a first hinge 350 may be provided at the first position 40 that enables the distance between the first ear portion 320 and the nose portion 340 to be adjusted, and a second hinge 360 may be provided at the second position that enables the distance between the second ear portion 330 and the nose portion 340 to be adjusted. The first hinge 350 may be configured such that the first ear portion 320 and the nose portion 340 are biased towards each other and the second hinge 360 may be configured such that the second ear portion 320 and the nose portion 340 are biased towards each other. As such, in these embodiments, the frame unit 30 may be fitted onto the head by applying a force on the frame unit 30 so as to pull the first ear portion 320 away from the nose portion 340, and to pull the second ear portion 330 away from the nose portion 340, as indicated by the arrows in FIG. 4B. This allows the first ear portion 320, the second ear portion 330, and the nose portion 340 to be positioned respectively at the first ear, the second ear, and the nose of the subject.

Since the first ear portion 320 and the second ear portion 330 are biased towards each other, the first ear portion 320 and the nose portion 340 are biased towards each other, and the second ear portion 330 and the nose portion 340 are biased towards each other, once the frame unit 30 is fitted on the head 12 of the subject, the frame unit 30 can be securely fixed in position by means of the biasing forces provided by the first hinge 350 and the second hinge 360. Hence, it would be unlikely for the frame unit 30 to fall off or dislocate during a hair clipping operation.

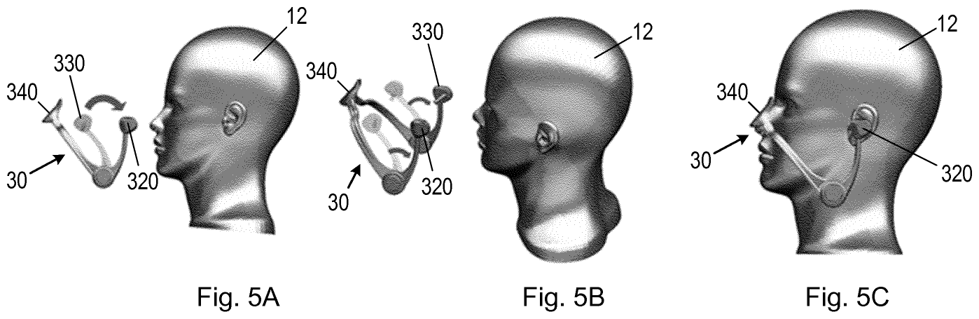

A sequence of how the frame unit 30 can be fitted onto the head of the subject is further demonstrated in FIG. 5A, FIG. 5B, and FIG. 5C. In FIG. 5A, a force is applied by a user on the frame unit 30 so as to pull the first ear portion 320 and the second ear portion 330 away from each other (as indicated by the curved arrow); in FIG. 5B, a force is applied by the user on the frame unit 30 so as to pull the first ear portion 320 away from the nose portion 340, and to pull the second ear portion 330 away from the nose portion 340 (also indicated by the curved arrows); and in FIG. 5C, the frame unit 30 is fitted onto the head 12 of the subject such that the first ear portion 320, the second ear portion 330, and the nose portion 340 are positioned respectively at the first ear, the second ear, and the nose of the subject.

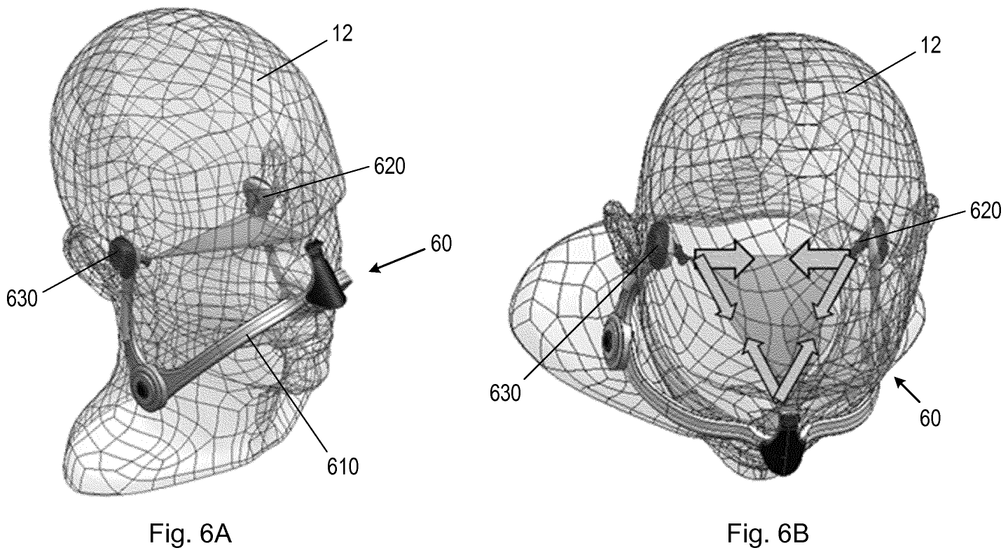

FIG. 6A and FIG. 6B are schematic drawings illustrating how a characteristic of the head of subject may be measured by measuring distances between components on a frame unit 60, according to another embodiment. Specifically, FIG. 6A illustrates a side view of the frame unit 60 while in use on the subject and FIG. 6B illustrates a top view of the frame unit 60 while in use on the subject.

In this embodiment, the frame unit 60 comprises a frame 610, a first ear portion 620, a second ear portion 630, and a nose portion 640. A first component is provided at the first ear portion 620, a second component is provided at the second ear portion 630, and a third component is provided at the nose portion 640. Each of the first component, the second component, and the third component may be a sensor, for example an electromagnetic sensor. Therefore, signal(s) from each of the first component, the second component, and the third component respectively represent a reference point at the first ear portion 620, the second ear portion 630, and the nose portion 640. These reference points may be mapped onto a reference coordinate system, for example by a control unit, so as to allow precise measurement of a characteristic of the head of the subject and/or a characteristic of a hair clipping unit. In addition, the triangle between the three reference points and/or the distances between the reference points may be used to determine a hair cutting pattern for use by a user in operating the hair clipping unit.

Since the three components in the present embodiment are each positioned at or near the ears and the nose of the subject, and these facial features are close to the skull of the subject and unlikely to move significantly during a measurement operation (unlike features such as mouth, cheeks, and chin), the respective reference points representing each of the three components are relatively reliable for the purpose of measuring a characteristic of the head of the subject.

Although it is described above that each of the first component, the second component, and the third component may for example be an electromagnetic sensor, in alternative embodiments at least one of the first component, the second component, and the third component may be other types of components which can facilitate a measurement of a characteristic of the head of the subject and/or a characteristic of the hair clipping unit.

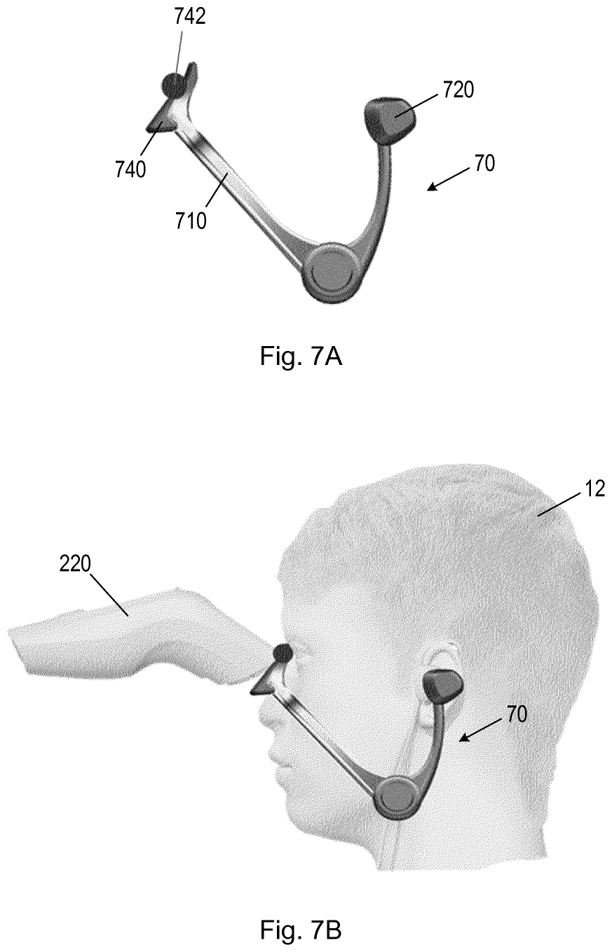

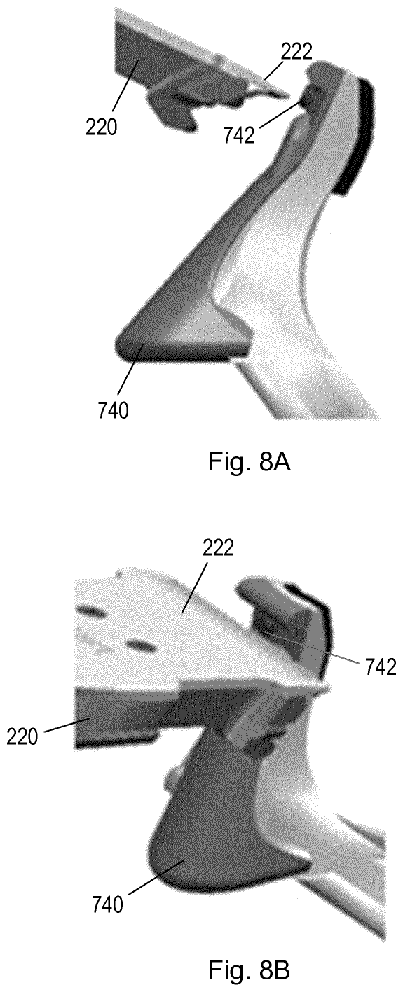

FIG. 7A and FIG. 7B are schematic drawings of a frame unit for use in a hair clipping system. FIG. 7A shows the frame unit on its own and FIG. 7B shows the frame unit being in use on a subject. FIG. 8A and FIG. 8B are schematic drawings demonstrating how an actuation unit on the frame unit of FIG. 7A and FIG. 7B can be actuated by a hair clipping unit 220.

The frame unit 70 as illustrated in FIG. 7A and FIG. 7B comprises a frame 710, a first ear portion 720, and a nose portion 740. In this embodiment, the frame 710 interconnects the first ear portion 720 and the nose portion 740. Furthermore, the frame 710 is configured such that, while in use on a subject, the frame 710 extends below a line interconnecting the first ear portion 720 and the nose portion 740 to enable access to the side of the face of the subject by a hair clipping unit in the hair clipping system.

The frame unit 70 further comprises an actuation unit 742 positioned at a predetermined position on the frame unit 70 for initiating a measurement of the position of the hair clipping unit. As shown in FIG. 7A and FIG. 7B, in the present embodiment the actuation unit 742 is a push-button positioned at the nose portion 740 of the frame unit 70. In other embodiments, the actuation unit 742 may be positioned at a different position on the frame unit, depending on a number of factors, such as the dimensions of the frame unit 70 and a material of the frame unit 70.

The actuation unit 742 may be configured to be actuated by a component of the hair clipping unit. This is demonstrated in FIG. 7B, FIG. 8A, and FIG. 8B. Specifically, FIG. 7A shows a contact between the hair clipping unit 220 and the actuation unit 742, FIG. 8A shows a side view of a cutting element 222 of the hair clipping unit 220 and the actuation unit 742, and FIG. 8B shows another perspective view of the cutting element 222 and the actuation unit 742. The actuation unit 742 may be actuated by applying pressure on the actuation unit 742 using the cutting element 222 of the hair clipping unit 220.

In the present embodiment, the actuation unit 742 is configured such that it can only be actuated by a component with a sharp edge, e.g. a cutting element on the hair clipping unit. Hence, accidental actuation of the actuation unit can be prevented. Also, since in this embodiment the actuation unit 742 is configured with the intention that it would only be actuated by the cutting element 222 of the hair clipping unit 220, an accurate measurement of the position of the cutting element relative to the frame unit can be achieved. This configuration also ensures that the hair clipping unit 220 is in an intended position when the measurement of the position of the hair clipping unit 220 is initiated. In addition, in such embodiments a measurement can be initiated by a user an intuitive and fool-proof manner at the frame unit 70. In some embodiments, a protective nose cap may be provided at the nose portion 740 so as to prevent accidental damage to the head of the subject.

Although it is described in the embodiment above that the actuation unit is configured to be actuated by a component of the hair clipping unit, in other embodiments the actuation unit may be configured to be actuated by other elements, such as a finger of a user, etc. Hence, in alternative embodiments, it is not necessary to actuate the actuation unit using a component with a sharp edge (e.g. a cutting element on the hair clipping unit), or to actuate the actuation using a hair clipping unit at all.

There is thus provided an improved frame unit for use in a hair clipping system and a system comprising the same, which overcome the existing problems.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1.-18. (canceled)

19. A frame unit for use in a hair clipping system, the frame unit comprising:
a frame;
a first ear portion for supporting the frame at the first ear of the subject;
a nose portion for supporting the frame on the nose of the subject;
and a second ear portion for supporting the frame at the second ear of the subject,
wherein the frame interconnects the first ear portion and the second ear portion via the nose portion,
wherein the frame is configured such that the frame extends substantially vertically downwards from the first ear portion to a first position and extends upwards from the first position to the nose portion,
wherein the frame is configured such that the frame extends substantially vertically downwards from the second ear portion to a second position and extends upwards from the second position to the nose portion;
wherein the frame is configured such that, while in use on a subject, the frame extends below a line interconnecting the first ear portion and the nose portion to enable access to the side of the face of the subject by a hair clipping unit in the hair clipping system and that the frame extends below a line interconnecting the second ear portion and the nose portion to enable access to the other side of the face of the subject by the hair clipping unit.

20. The frame unit according to claim 19, wherein the frame unit comprises the nose portion and a first hinge at the first position that enables the distance between the first ear portion and the nose portion to be adjusted.

21. The frame unit according to claim 20, wherein the first hinge is configured such that the first ear portion and the nose portion are biased towards each other.

22. The frame unit according to claim 19, wherein the frame unit comprises a second hinge at the second position that enables the distance between the second ear portion and the nose portion to be adjusted.

23. The frame unit according to claim 22, wherein the second hinge is configured such that the second ear portion and the nose portion are biased towards each other.

24. The frame unit according to claim 19, wherein the frame is configured such that the first ear portion and the second ear portion are biased towards each other.

25. The frame unit according to claim 19, further comprising at least a first component positioned on the frame for use in measuring a characteristic of the head of the subject and/or a characteristic of the hair clipping unit in the hair clipping system.

26. The frame unit according to claim 25, wherein the characteristic of the head of the subject comprises at least one of a size of the head of the subject and a shape of the head of the subject, and/or wherein the characteristic of the hair clipping unit comprises at least one of a position and an orientation of the hair clipping unit relative to the frame unit.

27. The frame unit according to claim 25, wherein the frame unit comprises a second component positioned on the frame for use in measuring the characteristic of the head of the subject and/or the characteristic of the hair clipping unit in the hair clipping system, wherein the first component is positioned at or near the first ear portion, and the second component is positioned at or near the at least one of the nose portion and second ear portion.

28. The frame unit according to claim 27, wherein the first component and the second component are configured to measure the distance therebetween to determine the size of the head.

29. The frame unit according to claim 25, wherein the characteristic of the hair clipping unit is the position of the hair clipping unit relative to the frame unit, and wherein the frame unit comprises an actuation unit at a predetermined position on the frame unit for initiating a measurement of the position of the hair clipping unit.

30. The frame unit according to claim 29, wherein the actuation unit is configured to be actuated by a component of the hair clipping unit.

31. A system comprising a frame unit according to claim 19, the system further comprising a control unit configured measure a characteristic of the head of the subject and/or a characteristic of the hair clipping unit.

32. A system comprising a frame unit according to claim 31, wherein the control unit is configured to determine a hair cutting pattern for use by a user in operating the hair clipping unit based on the measured characteristic of the head of the subject and/or the characteristic of the hair clipping unit.

33. A system according to claim 31, further comprising a hair clipping unit.
